(19) United States
(12) Patent Application Publication
(10) Pub. No.: US 2003/0076945 A1
(43) Pub. Date: Apr. 24, 2003

(54) Automatic longitudinal balance for solid state DAAs

(76) Inventors: George Huang, Schaumburg, IL (US); Bruno Marchevsky, Evanston, IL (US)

Correspondence Address: Robert J. Depke, MAYER, BROWN & PLATT, P.O. Box 2828, Chicago, IL, 60690-2828, US

(21) Appl. No.: 10/003,553

(22) Filed: Oct. 24, 2001

(51) Int. Cl. H04M 1/00; H04M 9/00

(52) U.S. Cl. 379/387.01; 379/394

(57) ABSTRACT

Systems and methods are utilized to balance differential gains and thereby improve signal-to-noise ratio where information is transmitted across differential signal lines. Adjustable impedances are selectively applied to one or more of the differential signal lines in order to more closely match the gains on the signal lines. As a result, signal-to-noise ratio is improved. In a preferred exemplary embodiment, a plurality of impedance elements are selectively connected to one or more differential signal lines in order to adjust the differential gain between the two signal lines such that they are essentially equal thereby improving the overall signal-to-noise ratio.

### BACKGROUND OF THE INVENTION

1. Field of the Invention

The present invention relates generally to the field of telecommunications devices. More specifically, the present invention is directed to systems and methods for improving the performance of telecommunications equipment through the use of automated impedance matching of telecommunications equipment in order to provide improved signal-to-noise ratio and achieve enhanced performance for the systems which employ this technology.

2. Description of the Related Art

In the field of telecommunications, it is well recognized that there is an ever-increasing demand placed upon the available bandwidth and data transmission capability of existing systems. In particular, over the past several years the existing systems and telephone lines of the public telephone service have now been used for transmitting substantially greater amounts of data in shorter periods of time. Specifically, for example, during this brief period of time we have seen analog modems that are capable of operating with existing telephone lines having data transmission rates that have increased from 14.4 to 28.8 and now 56 KBPS. This 200 percent growth in the data transmission rates has occurred without replacement of the primary infrastructure used as the conduit for this information.

The tremendous growth in the data transmission rates of these systems is not limitless. It has become increasingly important to ensure that the data transmission systems which are utilized satisfy more stringent specifications and standards. Even when the equipment which is utilized satisfies ever increasing standards and specifications, it has become difficult to achieve and maintain these high data transmission rates.

One related telecommunications system is disclosed in U.S. Pat. No. 5,875,235. This patent reference describes a transformerless Data Access Arrangement (DAA) which facilitates data transfer between high-speed modem devices and a central office telephone line. An analog-to-digital converter converts an analog signal received from a telephone line to one-bit modulated digital signal. As shown in FIG. 4 of this reference, transmit and receive drivers 308 and 310 couple sigma-delta converters to transmit and receive opt-couplers. The drivers optimize the impedance match between the respective converters and opto-couplers.

Another related system is disclosed in U.S. Pat. No. 5,802,169. This patent reference describes systems and methods for transmission system automatic impedance matching. The systems and methods described in this reference employ automatic selection of impedance values for matching against unknown line impedances. The systems and methods utilize storage of an expected set of desired return loss measurements at given frequencies and matches the calculated set against the actual measured return loss to arrive at a close approximation of line impedance. The system then makes automatic adjustments based on this determined close approximation. The starting point for the stored set of values are standard models established for each network.

In this reference, in order to accomplish automatic impedance matching an adjustable hybrid is utilized. The system is configured to assume a certain network impedance and based on this assumption, the network response follows a known pattern. During operation of the system, the first step is to solve for the unknown network impedance. This is accomplished by the emitting either a white noise, broadband noise or single frequency tone from the system to the telephone line and measuring the reflected energy at various frequencies. This approach, however, requires solving multiple simultaneous equations which can be a tedious task.

In order to avoid this problem, the system utilizes pre-stored models based on assumed variations of, for example, 10 percent, 15 percent, or 20 percent variations from nominal values of impedance at various frequencies. Calculations are made at several frequencies and are stored in memory. During operation, calculations are made at the same frequencies for each of same variances. Actual results are compared against the calculated results in order to determine the best match. Using this match, the adjustable hybrid is then set to optimize the impedance match. One shortcoming of this approach is that it is a very time-consuming solution and it requires additional memory and processing capability in order to make the appropriate comparisons. Additionally, this system is susceptible to differences in the relative line impedances which will result in gain variations and increased sensitivity to noise.

One object of the present invention is to provide systems and methods which are capable of more easily satisfying the stringent standards and specifications which are required in order to achieve the maximum data transmission rates of existing systems. Another object of the present invention is to provide telecommunications equipment and systems for transmitting data which are more mutually compatible and capable of achieving high data transmission rates. Yet another object of the present invention is to provide telecommunications equipment with improved impedance matching capabilities which can be easily performed without a substantial increase in cost of the devices. Other objects and advantages of the present invention will be apparent from the following Summary and Detailed Description of the presently preferred embodiments.

### SUMMARY OF THE INVENTION

The inventors of the technology disclosed herein have recognized that the performance of existing telecommunications systems can be improved and the ability to transmit data at higher rates may be maintained by providing systems and methods for matching and automatically balancing the impedance of the different signal lines in telecommunications equipment. In particular, the inventors have realized that improved performance can be achieved in existing telecommunications systems by finely adjusting and matching certain line impedances within the systems. By more closely matching the impedance of differential signal lines, it is possible to provide greater immunity to noise by balancing the gain on differential signal lines.

It has long been recognized that is important to match impedances within and between various components or elements of telecommunications systems. However, the inventors of the present invention have recognized that even within systems that are designed to be impedance matched there may be variations in the impedance characteristics of the systems and that the internal impedance characteristics of the systems may vary over time. As a result, the signal-to-noise ratio of the systems degrades resulting in reduction of the system performance characteristics. As a result, it is not only possible but likely that conventional telephone differential signal lines have relative variations in their impedance values which will result in uneven amplification and increased distortion due to noise. The present inventors have set forth herein systems and methods for overcoming these deficiencies of the prior art telecommunications systems.

Specifically, in a first exemplary embodiment, the inventors have identified a mechanism which may be used to achieve perfect or nearly perfect longitudinal balance on a Data Access Arrangement (DAA) for telecommunications equipment that utilizes capacitively coupled solid state DAA technology. Those skilled in the art will recognize that a Data Access Arrangement (DAA) is a collection of components which provide the circuitry needed to interface a telephone line to a digital signal processor component(DSP). The conventional DAA is used to extract a signal from the telephone line, digitize it and deliver it to a processing device which is typically a DSP. Conversely, data sent by the processor (DSP) must be converted to analog format and sent to the telephone line. The DAA is the conventional interface for performing these tasks.

In addition to exchanging these signals, the DAA must perform various sensing and control operations as is known in the art. For example, the DAA must inform the processor when a ring signal comes in from the central office, and it must be able to go off hook when requested in response to the receipt of the ring signal or some other command.

In typical existing systems, the central office sends analog or digitally encoded audio signals to the DAA in differential format. Conversely, in accordance with convention, the DAA transmits any signals that it sends to the central office differentially over the same two wires. For historical reasons, these wires are generally known as “tip” and “ring”.

Conventional DAA circuits utilize a transformer to couple the audio signal between a “hot” or line side to a “cold” or processor side. Through the use of this transformer, it is relatively easy to match the telephone line impedance to that of the hybrid DAA. The transformer also acts as an insulation barrier, so the equipment complies with standards regulations, mainly FCC part 68.

FIG. 1 is a simplified block diagram illustration of a conventional telephone line interface as is known in the prior art which is shown generally at 10. The hook switch 12 is used to connect the transformer 14 to the line, or for going off-hook. The hybrid 16 allows the transmitter to send a signal to the telephone line while preventing it from appearing on the receiver. The signal received by the DAA, Vₛ, is expressed by the equation

Vₛ=Vₜ−Vᵣ (1)

Where Vₛ is the signal received, Vₜ is the signal on the “tip” and Vᵣ is the signal on the “ring” wire. This type of arrangement provides significant immunity from common mode noise, a necessity for transmitting analog signals over long distances. This noise immunity is demonstrated through equations 2 and 3 below. Any interference sources along the wire path will induce approximately the same noise on both the tip and the ring wire. When the noise (N) is applied into equation (1) above, the original signal can still be recovered as the noise is cancelled by the differential nature of the input circuit.

Vₛ=(Vₜ+N)−(Vᵣ+N) (2)

Vₛ=Vₜ+N−Vᵣ−N (3)

The subtraction is performed to a high degree of accuracy when using a transformer in the DAA circuit as shown in FIG. 1. Receivers utilizing this component in its DAA show a high common mode rejection, resulting in good noise immunity. To reduce costs and simplify the approvals process, a DAA on a chip approach is needed or desired. This solid state DAA typically will have two identical input circuits, each carrying the tip and ring signals independently. The subtraction indicated by equation (1) is carried inside a silicon chip.

FIG. 2 illustrates a conventional configuration for a solid state receiver which is shown generally at 20. The differential amplifier 22 is implemented inside a chip as is known in the art. Gₜ and Gᵣ represent the combined gain resulting from the remaining circuits needed to couple the phone line to the chip, the hybrid, line loading, etc. for each of the tip or ring circuit arms. One problem with this conventional design is that the two paths carrying the tip and ring signal are physically independent and are typically implemented with different physical components. Even if the physical components are well chosen, variations of values even within the tolerances of the components may make it impossible to perfectly match the gain of both signal paths. The input equation for a conventional implementation of a solid state DAA is shown below:

Vₛ=GₜVₜ−GᵣVᵣ (4)

In equation 4, Gₜ and Gᵣ are the gains for the tip and ring arms of the circuit, respectively. Equation (6) below can be derived by applying common mode noise (N) as shown.

Vₛ=Gₜ(Vₜ+N)−Gᵣ(Vᵣ+N) (5)

Vₛ=GₜVₜ−GᵣVᵣ+N(Gₜ−Gᵣ) (6)

The inventors have recognized that the common mode rejection characteristic of the DAA suffers in a direct proportion to the gain mismatch between the tip and ring signal paths. The gain mismatch is in direct proportion to the variations of the line impedances. The result is a drop of signal to noise ratio (SNR) characteristic of the input circuit, causing some degradation in performance of the DAA. In order to equalize the difference in gains thereby overcoming the mismatch problem so the SNR can be maximized, the inventors have determined that an adjustable impedance element should be added to one or both of the tip or ring signal paths. The variable impedance or impedances should desirably provide enough range to make Gₜ=Gᵣ. The presence of this element or elements will thereby compensate for component tolerances, line mismatches and other factors that contribute to the gain mismatch. Through matching of the line impedance it is, therefore, possible to have resultant differential signal that is more immune to noise.

This variable impedance circuit is preferably adjustable on the fly by a signal processor with access to the data stream coming from the receiver in a preferred exemplary embodiment. In accordance with a preferred exemplary embodiment, adjustable impedances are connected to one or both of the tip and ring signal lines that are input to a differential amplifier. The adjustable impedances are selected such that the respective gains on each of the tip and ring signal lines are matched thereby minimizing the effect of any noise on the signal lines and improving the overall signal-to-noise ratio. As noted above and described in more detail below, in the preferred exemplary embodiment, the adjustable impedances are preferably automatically selected in order to achieve a more equal balance of the signal line gains.

### BRIEF DESCRIPTION OF THE FIGURES

FIG. 1 illustrates a conventional telephone line connection;

FIG. 2 illustrates the relative gains achieved with a conventional solid-state DAA;

FIG. 3 illustrates a first exemplary embodiment of the present invention; and,

FIG. 4 illustrates the details of a first exemplary embodiment of the present invention.

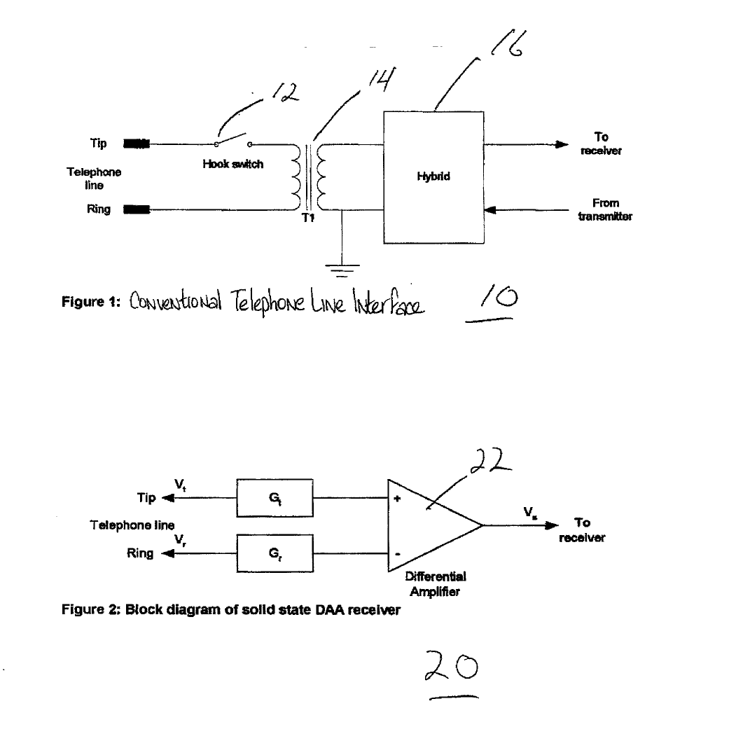

### DETAILED DESCRIPTION OF THE PRESENTLY PREFERRED EMBODIMENT

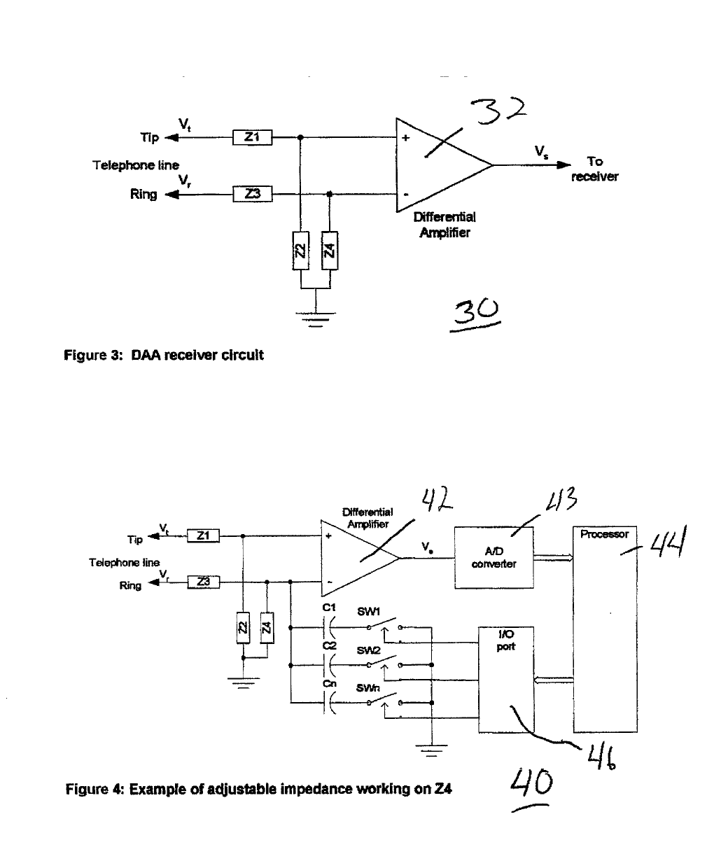

FIG. 3 illustrates a first exemplary embodiment of the present invention which is shown generally at 30. FIG. 3 illustrates the equivalent circuit of the receiver section of the DAA. In accordance with the preferred exemplary embodiment, at least one of the impedances Z1-Z4 and preferably at least one of the impedances designed Z2 and Z4 is adjustable in order to achieve balanced differential amplification. The ratio between impedances Z1 and Z2 determine Gₜ, while impedances Z3 and Z4 determine Gᵣ. Typically Z1 and Z3 will include the impedance of the telephone line, hook switch and hybrid. Z2 and Z4 will reflect EMI suppressing devices, coupling capacitors, etc. Those skilled in the art will appreciate that any one of the impedances Z1 through Z4 can be made adjustable in order to balance the gains. However, it is usually more practical to make Z2 and/or Z4 controllable since they are connected to the same reference as the differential amplifier 32. The differential amplifier 32 then provides an amplified differential signal.

In order to achieve the desired and preferred impedance selection to balance the gains, when the DAA is off hook or at any other appropriate time, a processing element (such as a CPU or DSP) will analyze the incoming signal and control the adjustable gain to determine the best possible gain match for both signal paths. The best match will provide the lowest possible noise floor. Accordingly, in a preferred exemplary embodiment, the DSP is programmed to identify the lowest noise floor possible based on selection of the variable impedances.

FIG. 4 illustrates one specific exemplary embodiment of the gain matching concept which is shown generally at 40. In this particular implementation the impedances are capacitive. However, those skilled in the art will appreciate that inductive members or a combination of inductive and capacitive impedance elements may be selectively connected in order to vary the impedance as desired. To maintain the gain and phase shift constant throughout the operating frequency range of the signal, the matching impedance must also be capacitive and capacitive elements are therefore preferred. However, it should be recognized that the same concept applies equally well for resistive, inductive or capacitive impedances as well as any combination of these elements. The only difference would be the type of element used to control the gain. If the impedances were mostly resistive, a controllable resistor would probably be the best circuit to use.

As shown in FIG. 4, Z4 is selected to be the adjustable component and adjustment is made by adding additional capacitors in parallel. Because the impedance to be matched is primarily capacitive, a bank of capacitors, C1 through Cn, were added. These capacitors can be selectively placed in parallel with Z4, depending on the state of the switches SW1 through Swn. Closing one or more the switches connects additional capacitive members in parallel to the impedance Z4. Although only parallel connections are shown, those skilled in the art will appreciate that parallel and/or serial connections of additional impedance members may be selectively made in order to alter the impedance and thus the relative gain as described above.

In the preferred exemplary embodiment, differential amplifier 42 provides an amplified differential signal to analog to digital converter 43. An output from the analog to digital converter 43 is provided to the DSP processor 44 which analyzes the samples received from the A/D converter, representing the input signal, and determines the amount of noise present. This step is performed for each of the possible impedance values in order to identify the preferred match. Alternatively, measurements may be made of the relative noise at selected ones of the possible impedance values. The processor then can be used to perform some computations in order to determine which combination of switches should be set in order to minimize the noise floor. Specifically, these calculations may be utilized in order to identify the appropriate impedance adjustments in order to maximize the signal-to-noise ratio. The system then controls the switches accordingly using the I/O ports 46 in order to choose the appropriate impedance to maximize the signal-to-noise ratio.

We claim:

1. A system for improving the signal-to-noise ratio of a differential signal comprising:
first and second signal lines connected to corresponding first and second inputs of a differential amplifier; and
a means for adjusting an impedance connected to at least one of the signal lines.

2. The system for improving the signal-to-noise ratio of claim 1, further comprising a controller for selectively adjusting the means for adjusting the impedance of claim 1 in order to achieve and improve signal-to-noise ratio.

3. The system for improving the signal-to-noise ratio of claim 1, further comprising a plurality of impedance elements selectively connected to at least one of the signal lines by a corresponding plurality of switch members.

4. The system for improving the signal-to-noise ratio of claim 3, wherein at least some of the impedance elements are capacitors.

5. The system for improving the signal-to-noise ratio of claim 1, further comprising a means for adjusting an impedance connected to each of said first and second signal lines.

6. A system for improving the signal-to-noise ratio of a differential signal comprising:
first and second signal lines connected to corresponding first and second inputs of a differential amplifier; and
a plurality of impedance members selectively connected to at least one of the signal lines with a plurality of switches.

7. The system for improving the signal-to-noise ratio of claim 6, further comprising a controller for selectively connecting the impedance members with the switches in order to achieve an improved signal-to noise ratio.

8. The system for improving the signal-to-noise ratio of claim 6, wherein at least some of the impedance elements are capacitors.

9. The system for improving the signal-to-noise ratio of claim 6, further comprising a plurality of impedance members selectively connected to each of the signal lines with a plurality of switches.

10. A method for improving the signal-to-noise ratio of a differential signal comprising the steps of:
providing first and second signal lines connected to corresponding first and second inputs of a differential amplifier; and
selectively changing an impedance connected to at least one of the signal lines.

11. The method for improving the signal-to-noise ratio of claim 10, further comprising a step of selectively connecting one or more of a plurality of impedance elements to at least one of the signal lines with switch members.

12. The method for improving the signal-to-noise ratio of claim 10, wherein at least some of the impedance elements are capacitors.
